(19) United States
(12) Patent Application Publication
(10) Pub. No.: US 2010/0189258 A1
(43) Pub. Date: Jul. 29, 2010

(54) METHOD FOR DISTRIBUTING AN AUTHENTICATION KEY, CORRESPONDING TERMINAL, MOBILITY SERVER AND COMPUTER PROGRAMS

(75) Inventors: Mohamed Kassab, Cesson Sevigne (FR); Karine Guillouard, Chantepie (FR); Jean-Marie Bonnin, Corps Nuds (FR); Franck Griffon, Saint Hilaire Saint Mesmin (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/664,611

(22) PCT Filed: Jun. 12, 2008
(86) PCT No.: PCT/FR2008/051053

§ 371 Date: Dec. 14, 2009

(30) Foreign Application Priority Data
Jun. 14, 2007 (FR) 0755769

(51) Int. Cl. H04W 12/06; H04L 9/08; H04W 12/04

(52) U.S. Cl. 380/247; 380/281

(57) ABSTRACT

A method and apparatus are provided for early distribution of at least one encryption key intended for securing a communication to be set up on the link layer of a cellular network formed of a plurality of cells, each controlled by an attachment point, between a mobile terminal and a set of attachment points, termed the target attachment points. The includes, for at least one target attachment point: creation of an encryption ticket containing an encryption key, enciphered on the basis of at least one authentication key specific to this target attachment point; receipt of the enciphered encryption ticket, by way of a current attachment point to which the mobile terminal is connected; identification, of a means of deciphering the enciphered encryption ticket, with the aid of the at least one authentication key, making it possible to obtain the encryption key.

### CROSS-REFERENCE TO RELATED APPLICATIONS

This Application is a Section 371 National Stage Application of International Application No. PCT/FR2008/051053, filed Jun. 12, 2008 and published as WO 2008/155508 on Dec. 24, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of radio communications in cell networks. More specifically, the disclosure relates to improving the transition of a mobile terminal from a current cell to a neighboring cell, when a terminal moves inside the network.

aspects of the disclosure can be applied for example in the field of radio networks using WiFi, GSM or again the WiMax type attachment points.

### BACKGROUND OF THE DISCLOSURE

This mechanism is generally called “handover” which can also be described as an “inter-cell transfer procedure”.

According to classic techniques, the handover procedure requires a phase of negotiation between radio attachment points, requiring a phase of discovery of neighboring attachment points. In addition to these different phases of discovery, there are procedures for managing the security of the link set up between the mobile terminal and the attachment point. For example, the IEEE802.11i standard guarantees the authentication of the user (through IEEE802.1X procedures) and ensures the confidentiality of the exchanges by preparing authentication keys (here below called material) and encipherment keys. In the context of the implementation of IEEE802.1X procedures, the attachment points are called access points.

An IEEE802.11i association is obtained by following successive steps whose object is a definition of a Master Key (MK) known to a terminal and one authentication server only as well as a “Pairwise Master Key” (PMK) created respectively by the terminal on one hand and by the authentication server on the other. The server transmits it to an access point with which the terminal wishes to implement a secured communications link. Such a communications link starts with a mutual authentication by the terminal and the access point in order to make sure that they possess the same PMK.

This authentication procedure activated by the access point corresponds to an exchange of four messages known as a “4-way handshake” and leads inter alia to generating the Pairwise Transient Key (PTK) encipherment keys. This 4-way handshake is followed by an exchange of two messages or “Group-Key handshake” by which the terminal can acquire the Group Transient Key (GTK) required to encipher the broadcast frames. The successful exchange leads the access point to unblock its IEEE802.1X controlled port and the terminal can then send and receive its data traffic.

However, the complete IEEE802.11i standardized procedure leads to relatively lengthy re-association times of the order of one second. Such re-association times are incompatible for a terminal in a situation of user mobility relative to real-time services requiring latency times of less than 50 ms (such as for example Voice over IP services).

However, the IEEE802.11i standard permits IEEE802.1X pre-authentication procedures which enable this step to be performed before a handover and enables the direct launching of the 4-way handshake once the handover has been made. However, such pre-authentication procedures are subjected to very strict conditions to ensure that the IEEE802.11i standard is met.

Solutions of fast pre-authentication prior to a handover procedure have been proposed, especially in the document by M. Kassab, A. Belghith, J-M. Bonnin, S. Sassi, “Fast Pre-Authentication based on Pro-active Key Distribution for IEEE802.11 Infrastructure Networks”, for the WMuNeP 2005 conference: First ACM Workshop on Wireless Multimedia Networking and Performance Modeling, October 13, Montreal, Canada, 2005, Proceedings p. 46-53. These approaches propose to optimize the step of secured re-association between a terminal and a target access point by means of two different solutions, one called “PKD with IAPP caching” and the other called “PKD with anticipated 4-way handshake”.

In both these cases, the principle of these proposals is based on the assumption that a PMK authentication key is created and known to a terminal and the access point with which the terminal is seeking to get associated before the request for association (application of the Proactive Key Distribution or PKD).

According to the principle of the PKD, a PMK is no longer negotiated between the terminal and the authentication server during each new request for re-association (which increase the time needed for the re-association), but this PMK is created and transmitted to the target access point by the server itself, on the basis of the current PMK key (of the current access point) as well as the identity of the station and that of the target access point.

Mutual authentication between the terminal and the access point is then ensured when the terminal and the target access point execute the “4-way handshake” used to ascertain that the terminal and the access point have the same PMK keys material.

In the first approach: “PKD with IAPP caching”, once the PMKn key has been generated and transmitted to the access point APn, the PKD method is “extended” to perform a pre-distribution of the “PTK” keys; an encipherment key “PTK_{T}” corresponding to the target access point is generated recurrently by the current access point on the one hand and by the terminal on the other hand, on the basis of the current “PMK” and “PTK”, the identity of the terminal and that of the target access point.

The choice of such a relationship between the entities is arbitrary. However, the use of the current “PTK” limits the life span of the “PTK_{T}” key generated by this relationship and the use of the current PMK key by the current access point proves the reciprocal trust between this access point and the authentication server (indeed, the latter must prove that the key has been generated by a trustworthy access point, namely the current access point). This reinforces the robustness of the relationship as compared with the relationship using only the current “PTK”.

Furthermore, it is only the current access point and the terminal that are capable of generating this new PTK_{T} key. It is the current access point which is then given the task of transmitting this new PTK_{T} to the target access point through a secured link between the two access points. Only the terminal, the current access point and the target access point can use this PTK_{T}.

Thus, only the creation of the group key GTK remains to be done during the association between the terminal and the target access point, thus reducing the association step by eliminating the exchange of the four messages of the 4-way handshake. The use of the current PTK to generate the target PTK_{T} enables the temporary transfer of the trust set up between the terminal and the current access point to the target access point.

The second approach “PKD with anticipated 4-way handshake” is an alternative approach for reducing the association time by carrying out the “4-way handshake” step with the target access point through the current access point by anticipation. This means that as soon as the terminal knows its target access point, it carries out a mutual authentication with it, before performing the “handover”. The step of association with the target access point thereafter comprises only the “Group-Key handshake”.

These two approaches nevertheless have drawbacks.

In a first stage, the “PKD with IAPP caching” procedure leads to a situation where a current access point knows the PTK_{T} of a target access point of a terminal.

Now, this is not compliant with the IEEE802.11i. standard. Indeed, if the current access point is compromised, the PTK_{T} may be transmitted to ill-intentioned terminals and/or access points. Besides, the PMK material is not exploited by the target access point, and the procedure leads only to a temporary mutual authentication between the target access point and the terminal, provided by the execution of the “Group-Key handshake”. Consequently, as soon as the terminal is associated with the new access point, a standard mutual authentication must be executed leading to the mutual verification of identity in proving the possession of an identical PMK and the creation of a new key PTK_{T1}.

Furthermore, according to the procedure for creating the “GTK”, an alternative approach in which a target access point APn and the terminal themselves generate the PTK_{T}, from the PMKn, of the identity of the terminal and the identity of the target access point would not be satisfactory because the execution of the group key handshake would then not suffice to ensure mutual authentication between the new access point and the terminal, in order to ascertain the position of an identical key PMKn.

The “PKD with anticipated 4-way handshake” procedure for its part makes it necessary to set up an exchange of several messages between the terminal and its target access point through the current access point. This exchange must therefore be done in parallel with the data exchanges set up with the current access point. The smooth running of the procedure then depends on the load of the current access point and of the time lag left for the terminal before execution of the “handover”.

The main drawbacks of the prior-art techniques may be summarized thus:
there is a need to maintain information or contexts in caches at the routers or access points without having advance knowledge of whether the data will be effectively used or not;
when the authentication material (of the MK or PNK type) is distributed in advance, the procedure of mutual authentication between the terminal and the access point and of setting up the encipherment keys (of the 4-way handshake type) is still to be performed. This procedure represents a minimum of four messages to be exchanged between the terminal and the target access point. Thus, when it is done reactively (i.e. once the handover has started), it leads to a non-negligible additional association time; when it is done proactively (i.e. before the handover), there is a risk that it will not be completed since it is then executed in parallel with the data communications set up with the current access point, the load of which is not known;
these techniques also rely on a restricting assumption that a preset secured link exists between the current access point and the target access point. Such an assumption leads to complex configurations and a secured connection is required between two potentially neighboring access points. In principle, it is therefore necessary that any access point knows its neighboring access points and that this information is also known to the terminal.

### SUMMARY

An aspect of the disclosure relates to a method of anticipated distribution of at least one encipherment key designed to secure a communication to be set up on the link layer of a cell network formed by a plurality of cells, each controlled by an attachment point, between a mobile terminal and a set of attachment points known as target attachment points.

According to an embodiment of the invention, such a method comprises, for at least one target attachment point, the following steps:
creating an encipherment ticket containing an encipherment key, encrypted on the basis of at least one authentication key proper to this target attachment point;
receiving said encrypted encipherment key by means of a current attachment point to which said mobile terminal is connected;
identifying a means for decrypting said encrypted encipherment key by means of said at least one authentication key, making it possible to obtain said encipherment key.

Thus, an embodiment of the invention makes it possible to obtain a preliminary securing of a communication call to come between a terminal and a target attachment point to which the terminal is liable to get connected, without any knowledge on the part of the current attachment point, i.e. the point by which the ticket transits before reaching the target attachment point, of the private cryptographic information of the target attachment point. Indeed, according to prior-art techniques which aim at reducing the time needed for a change of cell by the terminal, the private cryptographic information of the target attachment points transit in unencrypted form through the current attachment point. Now, if this attachment point is corrupted or hacked, these pieces of information can be exploited in an ill-intentioned way. An embodiment of the invention makes it possible especially to overcome this drawback by enciphering these pieces of private information before they transit the current attachment point. Furthermore, an embodiment of the invention increases the overall level of security of the transactions coming into play between the mobile telephone and the target attachment point in leaving only this target attachment point with the task of identifying the means needed to decrypt the encipherment ticket. For example, in one particular mode of implementation of an embodiment of the invention, adapted to the IEEE 802.11i standard, the target attachment point can use the information element “RNS” which is integrated into certain managing frames and enables the terminals and the attachment points to indicate their capacities for managing security policies to the peers with which they wish to communicate.

According to one particular embodiment of the invention, said method furthermore comprises a step of storage, by said target attachment point, of said received encipherment ticket within a specific space, according to a predetermined preservation parameter.

Thus, the method for distributing of an embodiment of the invention makes it possible to preserve, within target attachment points, the received encipherment ticket enabling each attachment point to set up a secured link level communication with the terminal when this terminal changes its attachment point. This storage is managed according to a predetermined preservation parameter to enable efficient administration of this parameter especially with respect to possible security constraints and time-related constraints.

According to one particular characteristic of an embodiment of the invention, said method comprises a preliminary step for determining said set of target attachment points by means of a neighborhood graph associated with said cell network.

Thus, only the attachment points that are part of the potential targets reachable by the terminal during its movement are the object of an anticipated distribution of encipherment and authentication keys. Such preliminary determining of the set makes it possible to prevent the subsequent distribution of information to attachment points that do not need such information.

According to one particular embodiment of the invention, said encipherment ticket is created by said terminal and said encipherment ticket furthermore comprises a first piece of information representing an identifier of said terminal.

Thus, at reception of the encipherment ticket, the target attachment point is capable of determining the terminal from which this encipherment ticket comes. An embodiment of the invention therefore makes it possible to prevent terminal identity theft by directly associating the encipherment key with a given terminal in the ticket.

According to one particular embodiment of the invention, said encipherment ticket is created by said target attachment point and said encipherment ticket furthermore comprises a first piece of information representing an identifier of said terminal.

Thus, such an embodiment enables the network to fully control the choice of encipherment keys as well as the means of creating encipherment tickets. These characteristics can be important for an operator.

According to one particular embodiment of the invention, said method furthermore comprises a preliminary step of transmission, for each target attachment point, of a second piece of information representing a possible implementation of a handover procedure from said mobile terminal.

Thus, an embodiment of the invention can be used to prepare the attachment points that may go through the implementation of a handover procedure. Such preparation enables the target attachment point, for example, to reserve resources prior to this implementation, especially in order to accelerate it.

According to one particular characteristic of an embodiment of the invention, said second piece of information furthermore comprises a piece of data belonging to the group comprising:
an identity of said terminal;
a piece of information representing a piece of authentication material proper to said terminal.

Thus, the target attachment point has advance knowledge of which terminal is liable to get attached and/or possesses the authentication material proper to this terminal, for example in the form of a “Primary Master Key” enabling the generation of the identification data needed. It is therefore not possible to prompt the attachment of a terminal that has not been announced at the target attachment point. By this means, the security level of the entire exchange procedure is heightened.

According to a particular characteristic of an embodiment of the invention, said method comprises a step for temporarily saving said second piece of information up to the implementation of said handover procedure.

Thus, the attachment point is always in a position to know the identity of the authentication material needed for the attachment of the terminal or have this authentication material available to it.

According to one particular embodiment of the invention, said method comprises a step for eliminating said second piece of information when a time limit for saving said second information is reached.

Thus, the risks of identity theft are reduced by giving the information that identifies a terminal only a limited life span. Thus, if the terminal has not begun a handover procedure in the time allotted to it to do so, it can no longer carry out this handover with the information that had been available at the target attachment point. A new distribution is necessary at the target attachment point in order that the authentication of the terminal may take place and that the handover procedure may be performed. Naturally, this new distribution can take place through the distribution method that is the object of an embodiment of the invention.

An embodiment of the invention also pertains to a system of anticipated distribution of at least one encipherment key designed to secure a communication to be set up on the link layer of a cell network formed by a plurality of cells, each controlled by an attachment point, between a mobile terminal and a set of attachment points known as target attachment points.

According to an embodiment of the invention, such a system comprises, for at least one target attachment point:
means for creating an encipherment ticket containing an encipherment key, encrypted on the basis of at least one authentication key proper to this target attachment point;
means for receiving said encrypted encipherment key by means of a current attachment point to which said mobile terminal is connected;
means for identifying a means for decrypting said encrypted encipherment key by means of said at least one authentication key, making it possible to obtain said encipherment key.

In such a system, the means for creating may be included within a mobile communications terminal and the means for receiving may be situated within the target attachment point. The means for identifying are implemented by the target attachment point. In another embodiment of the system, these means for creating may be situated at the target attachment point may be situated at the mobile terminal. The means for identifying are then implemented by the mobile terminal.

Another embodiment pertains to a device capable of acting in a system of anticipated distribution of at least one encipherment key designed to secure a communication to be set up on the link layer of a cell network formed by a plurality of cells, each controlled by an attachment point, between a mobile terminal and a set of attachment points known as target attachment points.

According to an embodiment of the invention, such a device comprises means for creating an encipherment ticket containing an encipherment key, encrypted on the basis of at least one authentication key proper to this target attachment point.

In one particular embodiment, such a device can take the form of a communications terminal which is capable of transmitting and receiving information within a cell network formed by a plurality of cells.

An embodiment of the invention also pertains to an attachment point capable of acting within a system of anticipated distribution of at least one encipherment key designed to secure a communication to be set up on the link layer of a cell network formed by a plurality of cells, each controlled by an attachment point, between a mobile terminal and a set of attachment points known as target attachment points.

According to an embodiment of the invention, such an attachment point comprises means for receiving an encipherment ticket containing an encipherment key, encrypted on the basis of at least one authentication key proper to said target attachment point, by means of a current attachment point to which said mobile terminal is connected.

According to one particular embodiment, said attachment point comprises means for identifying a means for decrypting said encrypted encipherment key received, by means of said at least one authentication key, making it possible to obtain said encipherment key.

Another aspect pertains to a computer program product downloadable from a communications network and/or recorded on a computer-readable carrier and/or executable by a micoprocessor and comprising program code instructions for executing the method of anticipated distribution as described here above.

### BRIEF DESCRIPTION OF THE DRAWINGS

Other features and advantages shall appear more clearly from the following description of a particular embodiment, given by way of a simple illustratory and non-restrictive example and from the appended drawings, of which:

FIG. 1A is a simplified user diagram of the method of an embodiment of the invention;

FIG. 1B is a simplified user diagram of the re-association of a terminal following the execution of the method according to an embodiment of the invention;

FIG. 2 illustrates a campus network implementing an embodiment of the method of FIG. 1;

FIG. 3 is an example of a layout of a set of attachment points of a sub-network of FIG. 2, within a building, as well as a corresponding neighborhood graph;

FIG. 4 is a tree of the creation and anticipated distribution of the encipherment keys corresponding to a movement of a terminal in the network of FIG. 3;

FIG. 5 is a user diagram showing the interactions between a terminal and the first attachment point with which it gets connected;

FIG. 6 is a user diagram having interactions between a terminal and the target attachment points during a movement of the terminal as illustrated in FIG. 4;

FIGS. 7A and 7B schematically illustrate the structures of an attachment point and a terminal respectively, implementing an embodiment of the invention.

### DETAILED DESCRIPTION OF ILLUSTRATIVE EMBODIMENTS

### 1. Definition of Abbreviations Used

In the present disclosure, the following acronyms and definitions have been used:
APn: n^{th} attachment point with which the terminal in a situation of mobility is associated;
APn_id: identifier of the attachment point APn which for example could be the MAC (machine) address of the attachment point;
MN_id: identifier of the terminal, which for example may be the MAC address of the terminal;
PMKn: authentication key corresponding to the attachment point “n” in the above description corresponds to the target attachment point;
PMKn-1: authentication key corresponding to the attachment point “n−1” which, in the following description, is also called a current attachment point;
PRF: non-reversible pseudo-random function used to generate the encipherment keys;
Snonce: random value created by the terminal or by the target attachment point. This value is created by the entity which creates the encipherment key and the enciphered ticket;
handover: inter-cell transfer procedure.

### 2. Main Aspects of an Embodiment of the Invention

An embodiment of the invention therefore proposes a novel approach enabling the anticipated distribution of the encrypted encipherment keys to the target attachment points and the subsequent setting of up a secured communications link at the link layer (layer 2 of the OSI model) between the terminal in a situation of mobility and the target attachment points prior to the opening of a secured communications link at the level of the layer 3 (network layer).

In other words, an embodiment of the invention can be used to respond to the problem of setting up a procedure for exchanging encipherment keys directly between a terminal and its target attachment point when the terminal is in a situation of mobility by mechanisms that are secured and fast, enabling for example the maintenance of the execution of a real-time application.

The solution provided by an embodiment of the invention consists in creating the encipherment key before the identification of a need for a handover, encrypting this piece of data by means of the terminal according to a first embodiment or by means of the target attachment point according to a second embodiment, with the material (the PMK type authentication keys) known solely to the terminal and the target attachment point without its being necessary to exchange higher-level keys of the MK or PMK type, i.e. without its being necessary to provide for link-securing architectures between the attachment points of the network.

Thus the attachment to the network is secured (by the fact that the pieces of exchange data are encrypted) as soon as the association is made at the link layer (layer 2) without awaiting the setting up of network connectivity (layer 3) between the terminal and the network.

According to a second embodiment, the full encipherment material (for example of the PTK type) is created and transmitted to the terminal concerned by the target attachment point itself by means of the current attachment point, again in a secured manner, i.e. this material is encrypted with data known only to the terminal and the target attachment point.

Depending on the mode of implementation of an embodiment of the invention, the creation of the ticket can therefore be done within the terminal or within the attachment point. The encipherment ticket will be received by the target attachment point if the terminal has created the ticket. The encipherment ticket will be received by the terminal if the target attachment point has created the ticket.

Thus, should the ticket be created by the mobile terminal:
When the terminal is associated with its current point, it obtains a list of potential target attachment points, for example through a centralized managing system that can transmit this type of information. The above is useful when it is the terminal that creates the encipherment ticket. If it is a target attachment point that takes charge of this creation, then the server should inform each of the potential target attachment points that it is a possible target and therefore that it must generate an encipherment ticket addressed to the mobile.
A list of security tickets associated with the previously generated list of attachment points is created. Each ticket associated with a specific target attachment point of the list consists of an encrypted encipherment context corresponding to this attachment point. This list is obtained as follows:

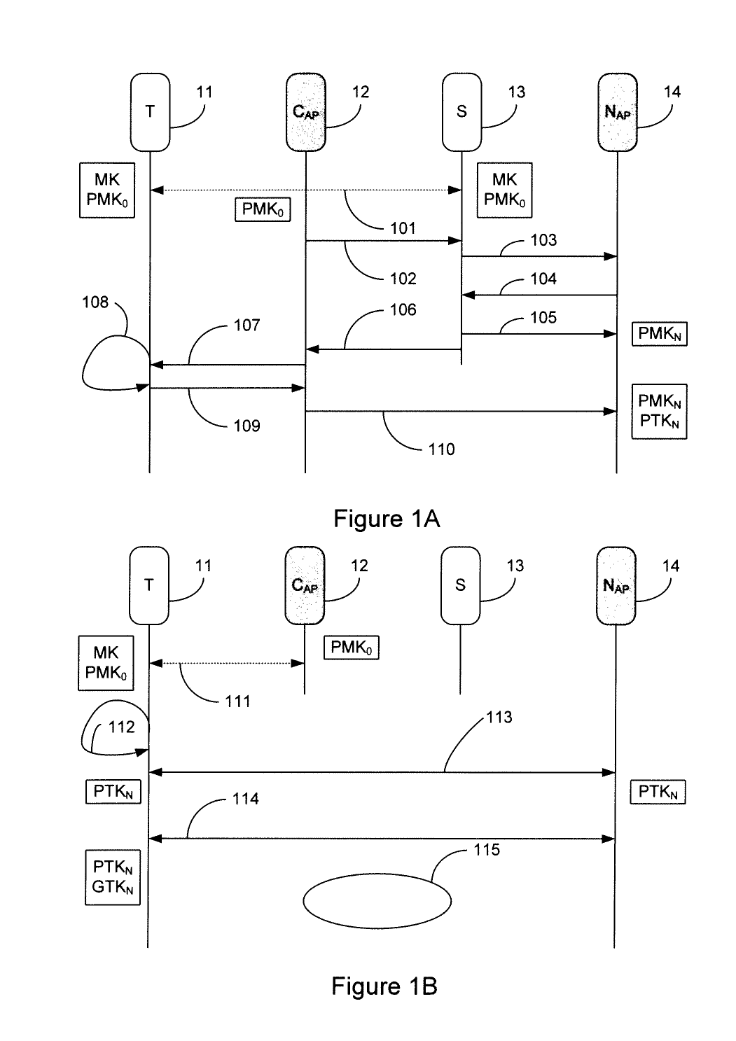

For each target attachment point of the list APn:
An encipherment key is created:
   PTKn=PRF(PMKn,Snonce,APn_id,MN_id)
Ticketn=(MN_id,PTKn)c=(MN_id,PTKn) encrypted with a key known to the target attachment point alone (for example PMKn)
List={APn_id, SeqNumb, Ticketn}, list of pairs (AP_id, ticket), each of the tickets being specific to an attachment point of the list. The field “SeqNumb” is specific to the target attachment point and is intended for the current attachment point to prevent attacks by re-transmission.
The list of tickets is transmitted to the current attachment point in a secure manner (list enciphered before sending);
In one particular embodiment of the invention, this list may be maintained in the cache of the current attachment point. According to one particular embodiment of the invention, the method is secured by imposing a life span on the tickets at the target attachment points. Thus, after the expiry of a ticket, the target attachment point will need a new ticket to be created and not a copy that it already has in its possession, coming from the cache of tickets of the current attachment point;
The current attachment point re-sends the ticket and identity of the corresponding terminal to each of the attachment points of the list, for example by means of a secured link; according to the second embodiment, the current attachment point conveys the list of tickets generated by all the target attachment points to the terminal.
Each attachment point of the list can also create a second cache associating the identity of the terminal and the received ticket, in optionally indicatinig a period of validity of these entries. If the key used by the terminal for encryption is known to the target attachment point, this attachment point can, from that very instant, decrypt the Ticketn and extract the corresponding PTKn at the terminal.
   in order that a decryption of this kind may be possible, in one particular embodiment of the invention (IAPP standard), it is proposed that the key used to encrypt the ticket should be determined directly from knowledge of the authentication method. Indeed, the authentication method is announced in the field “RSN IE” stated by the terminal in the frames “association-req” to the current attachment point. The field “RSN IE” is used by the attachment point to inform the mobile units of the authentication or re-authentication method to be used.
      According to one particular embodiment, an identifier pertaining to the re-authentication method is predefined. This identifier is recognized by all the entities that support the present method. It is therefore not necessary to exchange the value of this field between the attachment points. In one particular embodiment of the invention, when the current attachment point receives a ticket for a target attachment point, the current attachment point sends back the ticket to the target attachment point and informs it at the same time about the value of the field “RSN IE” corresponding to the concerned terminal.
      From this value, the target attachment point determines the authentication method used by the terminal and deduces the key used there-from (for example PMKn). The terminal performs an identical operation when it is not the creator of the ticket and must identify the decryption means;
During its re-association with the target attachment point, the terminal sends it a frame “reassociation-req” optionally including a field enabling the target attachment point to determine the way to decrypt the previously transmitted ticket (in certain modes of implementation, it is proposed that this field be the “RSN IE” field filled in by the terminal in the frame “association-req”) and the standard field indicating the former attachment point. This option is useful if the previous attachment point does not have the means to send the target attachment point this piece of information.
From the identity of the terminal transmitted through “reassocation-req” and the pre-authentication method, the target attachment point identifies, if it has not already done so, the way to decrypt the ticket Ticketn and extracts the corresponding PTKn from the terminal.
The attachment point launches the “Group-key handshake” procedure to distribute the GTKn.
The different steps described are illustrated with the diagrams of FIGS. 1A and 1B.

The connection of a terminal to the network is presented by FIG. 1A. A terminal 11 gets connected to a current attachment point 12. Prior to the setting up of communication, the terminal 11 and an authentication server 13 perform (101) a mutual authentication enabling the server 13 and the terminal 11 to have available the same authentication material MK and PMK₀. The key PMK₀ also possesses the current attachment point 12. The current attachment point 12 informs (102) the authentication server 13 that the terminal 11 is accepted on the network by the current attachment point 12. The authentication server 13 will prepare a list of the neighboring attachment points for the current attachment point. The figure shows only one neighboring attachment point 14. The authentication server 13 informs (103) the attachment point 14 that a terminal 11 is accepted on the network and asks if the attachment point 14 wishes to receive a key for this terminal 11. The neighboring attachment point 14 transmits (104) its acceptance to the authentication server 13 which transmits (105) the authentication key PMK_{N} to the neighboring attachment point 14.

The server 13 transmits (106) a list of neighboring attachment points to the current attachment point 12. The current attachment point 12 transmits (107) a list of potential target attachment points to the terminal 11 which generates (108), for each of the potential target attachment points, an encrypted encipherment ticket. The list of tickets is then transmitted (109) to the current attachment point 12 which in turn transmits (110) for each target attachment point 14 of the list (only one in the example) the encrypted key that corresponds to it, and each target attachment point 14 decrypts and extracts its PTK from the terminal.

Subsequently, during the movement of the terminal 11 (FIG. 1B), the pre-distribution method described by means of FIG. 1A enables a faster association of the terminal. There is a former association 111 existing between the terminal 11 and the current attachment point 12. The terminal 11 moves (112) to the neighboring attachment point 14. A standard re-association (113) is then made between the terminal 11 and the neighboring attachment point 14. However, unlike in the prior-art techniques, since the neighboring attachment point 14, through the method of an embodiment of the invention, already has the PTK of the terminal, there is no need to resort to the “4-way handshake” procedure in order to obtain this key. The terminal 11 and the neighboring attachment point therefore directly start (114) the “Group-Key Handshake” phase prior to the transmission of data (115).

In other words, the method of an embodiment of the invention enables the accelerated and secured distribution of the temporary encipherment keys (of the PTK type) which have a stronger refresh constraint stronger than that of the primary authentication material (of a PMK type).

In one particular embodiment of the invention, which is especially worthwhile when building a solution of preliminary negotiation of parameters controlled by the network of a communications operator, the encipherment ticket “Ticketn” is generated by the target attachment point itself, from the “PTKn”, which itself is built from “PMKn”, “MN_id”, “AP_id” and has a random value, an expression identical to that used by the terminal in the solution described here above.

The “MN_id” is determined by the reception of an imminent “handover” pertaining to the corresponding terminal. This notification may be sent out by the terminal itself or by a third-party entity (such as a mobility controller for example). This encrypted encipherment ticket is then sent by the target attachment point to the terminal through secured links between the target attachment point and the current attachment point on the one hand and between the current attachment point and the terminal on the other hand.

In this embodiment, optionally, as soon as the target attachment point is notified that the terminal will make a “handover” to its cell, the target attachment point prepares the encipherment key of the broadcast frames (GTKn type group key) corresponding to the set of associated stations and keeps it in a cache pending the time when the terminal will send a “association-req” to it. As soon as the terminal sends it an “association-req” frame, the attachment point broadcasts this group key to all the terminal stations attached to its cell.

In one complementary embodiment, it is optionally possible to introduce a controller of activation of the procedure for creating a ticket, either at the terminal or at the attachment point. Such a controller makes it possible to confirm an imminent “handover” of the terminal to the target attachment point.

In another embodiment, the current attachment point and the target attachment point may be of different technologies (“WiFi”, “WiMAX” for example).

In another embodiment, the ticket may include additional fields, not related to security, indicating the context of quality of services to be guaranteed at the terminal if the ticket is created by the terminal itself, indicating the context of quality of services that the target attachment point can offer if the ticket is created by the target attachment point (class of QoS, priority level etc). This makes it possible then to propose additional services after the connection has been set up and to exploit only one ticket to transmit several pieces of information needed for the re-association, in order to minimize the load of the signaling on the radio link.

Thus, in the solution provided by the method according to an embodiment of the invention:
The mutual authentication between the terminal and the target attachment point is provided by the following methods:
First of all, the terminal is based on the relationship of trust that it has set up with its current attachment point to send the ticket and the target attachment point bases itself on the relationship of trust set up with the current attachment point to accept this ticket. Hence, the holding of the ticket by the target attachment point implicitly indicates a transfer of the relationships of trust through the current attachment point. This trust that is set up however remains insufficient to fully ensure mutual authentication; it is complemented by the following method:
To decipher the content of the ticket (i.e. the PTK), the target attachment point needs the PMK (or other authentication material). During the re-association, the target attachment point starts a “Group-Key handshake” (i.e. a distribution of the GTK) on the basis of the PTK and therefore proves to the station that it has knowledge of the PMK since it has succeeded in deciphering the content of the ticket. Consequently, mutual authentication is provided by this last-named between the terminal and the attachment point.
The PTK created by the terminal remains valid so long as the PMK and known to the terminal and target attachment point is itself valid and so long as the life span of the PTK has not elapsed. If not, the terminal must refresh the PTK key and must transmit it to the target attachment point by the same method.
The fact of using the PMK key to encipher the ticket remains compliant with IEEE802.11i: indeed, it is sent only once and cannot be considered as the sending of a data traffic requiring the sending of several MAC frames. Thus, unlike the techniques of the prior art, the solution proposed by an embodiment of the invention is fully compatible with existing standards.
In one particular embodiment of the invention, it is possible that the list of potential target attachment points will be created by a third-party entity enabling for example a more efficient control of the list by the operator. In particular, the distribution of information to potential target attachment points may lead to information being kept at certain attachment points which will never be used. The optimizing of the distribution is conditional on efficient definition of the list of target attachment points, for example the exploitation of a neighborhood graph that is dynamically updated. This method departs from the context of the description of the solution.

### 3. Example of Implementation

The implementation described here below provides a mobile telephony service on WiFi in a secured WLAN deployed on a campus.

### 3.1 Context

A university campus is an extended space consisting of several buildings at a fair distance from one another. To improve logistical performance, it would be worthwhile to enable contact with staff members who are frequently on the move.

With the widespread use of WiFi technology, attachment points are being deployed in campuses almost everywhere. Indeed, the attachment points are deployed in meeting rooms, offices and lecture halls as well as less conventional spaces such as university cafeterias, student recreation areas and even outside buildings. Thus, we have complete WiFi coverage where the zones of coverage of the attachment points overlap one another.

It would therefore be worthwhile to apply this continuous access to offer a telephony service based on Voice over IP. In this mode of implementation of an embodiment of the invention, it is proposed to set up a WiFi mobile telephony system for campus staff members so that they can be contacted when moving within the campus.

### 3.2 Architecture

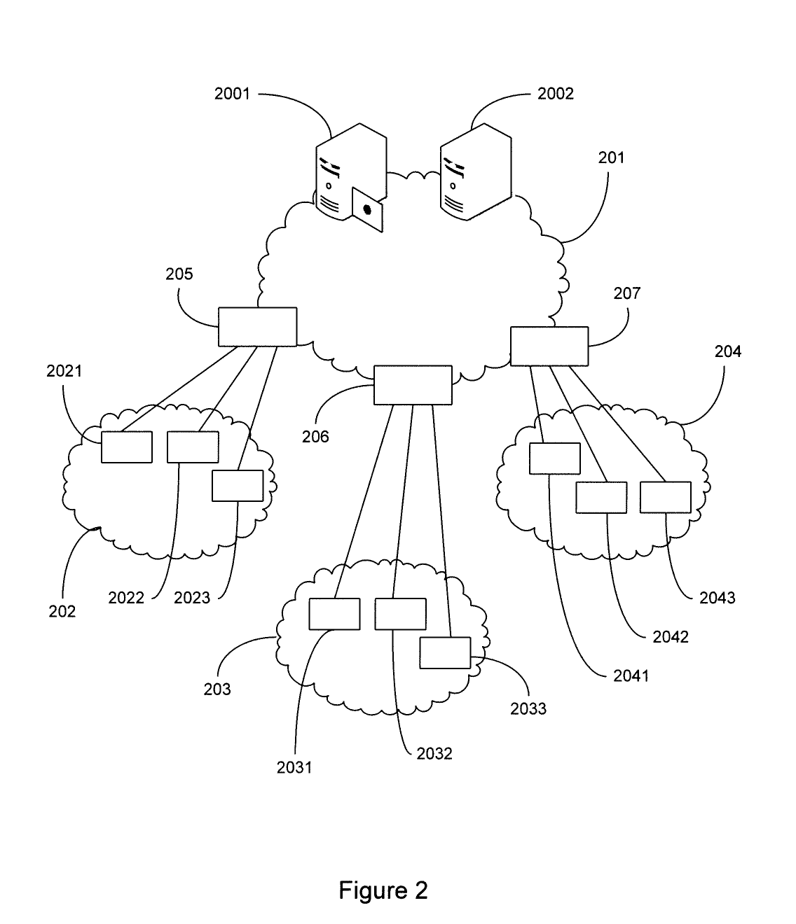

The architecture of the network of the campus consists of a set of sub-networks connected through gateways to a managing network which groups together the central managing entities such as the AAA (authentication, authorization, accounting) servers, the applications servers as described in FIG. 2.

Such a network comprises:
a campus managing network (201) comprising inter alia:
   an AAA server (2001);
   one or more applications servers (2002);
departmental sub-networks (202, 203, 204) connected by appropriate means (205, 206, 207) to the campus managing network (201) each comprising attachment points (2021, 2022, 2023, 2031, 2032, 2033, 2041, 2042, 2043),

As illustrated in FIG. 2, the attachment points are associated with the sub-networks to which they enable access.

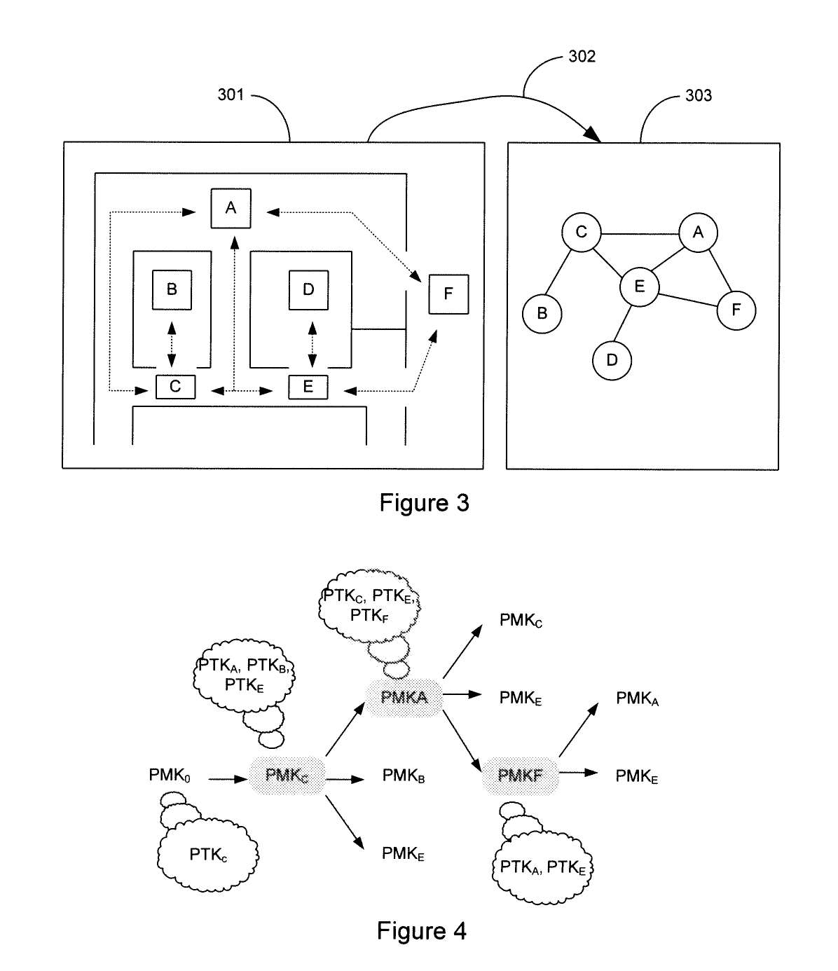

In this mode of implementation, the fast authentication method which is directly derived from the distribution method of an embodiment of the invention is based on the notion of neighborhood between attachment points to limit the pre-distribution of the keys during the pre-authentication phase. The neighborhood graph, defined by the fast authentication mechanism (FIG. 3), is managed by the AAA server (authentication server). Furthermore, this same server is responsible for the distribution of the “PMK” keys to the neighboring attachment points during the pre-authentication phase. These two functions assigned to the AAA server are taken charge of by its accounting function.

Thus, as represented by FIG. 3, it is assumed that the sub-network 301 as described in FIG. 2 (202, 203, 204), for example situated in a determined building, has six attachment points (A, B, C, D, E and F). For example, as presented in FIG. 3, the attachment point B is capable of entering into communication with the point C which is itself capable of communicating with A and E. The AAA server thus sets up (302) a neighborhood graph (303) representing the possibilities of successive communications between the attachment points.

The IAPP protocol defines a mechanism for securing communications between attachment points through a centralized authentication server. In this embodiment, the AAA server takes charge of this function by using the RADIUS protocol.

### 3.3 Scenario of Use and Exchange Diagram

In this section, we present a scenario of use based on the architecture considered preliminarily and illustrated by FIG. 3. We therefore consider an example of deployment of attachment points within a building as well as the corresponding neighborhood graph.

The building of the graph is based on the possibilities of movement of the users between the attachment points and the overlapping between coverage zones of the attachment points.

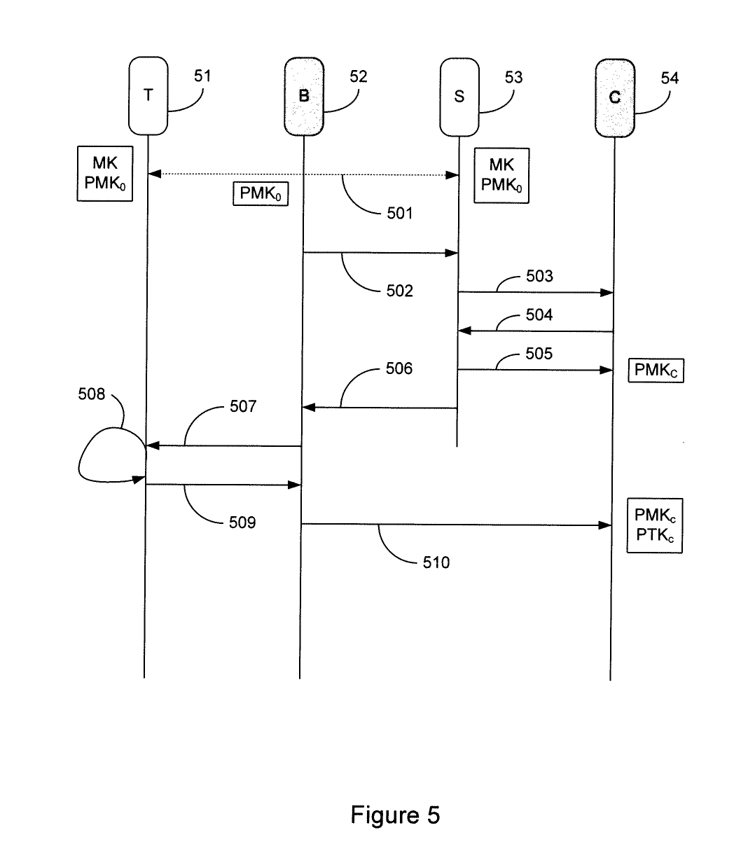

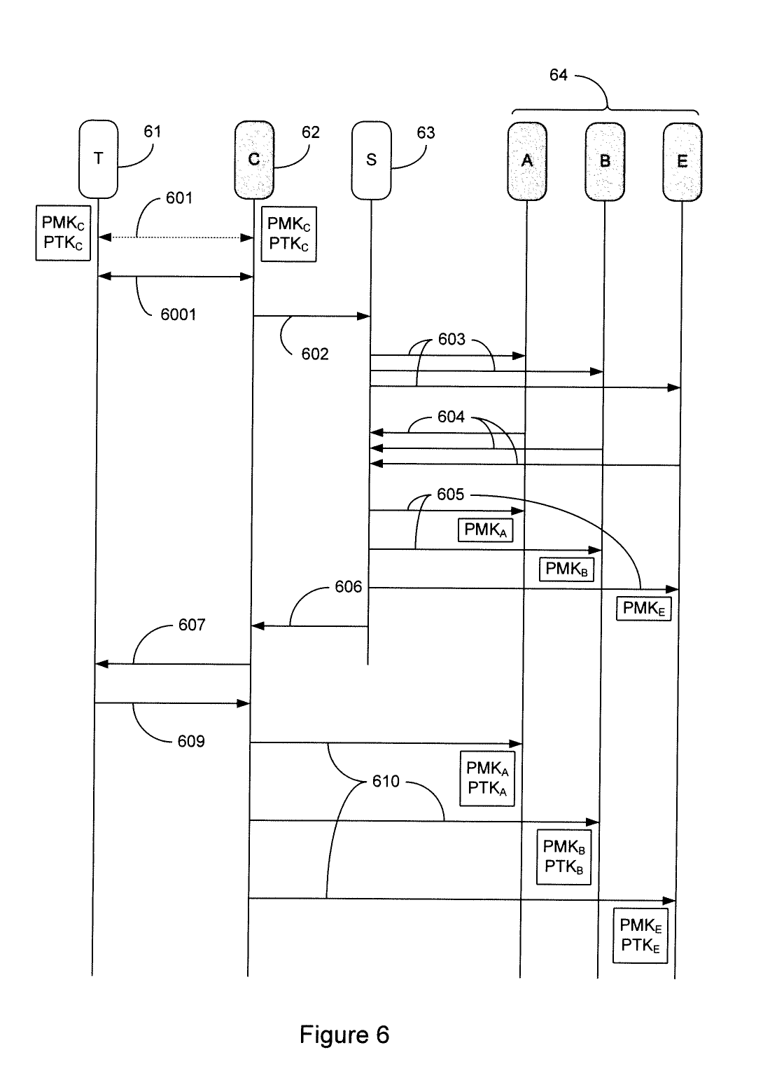

Here below, we present the diagrams of the exchanges that result from the movement of a station between a certain number of attachment points (FIG. 5 and FIG. 6). We consider a station moving successively between the attachment points B, C, A and F.

During the first attachment with the network, the mobile terminal gets associated with the attachment point B and carries out a complete authentication 802.11 which results in a first key PMK₀. At this point, the server AAA determines the neighbors of the attachment point B and initiates the pre-distribution of the PMK keys. Thereafter, the successive movements of the station between the neighboring attachment points give rise to a tree of PMK keys. FIG. 4 presents the tree corresponding to the sequence of movements considered.

Whenever the station gets re-associated with a neighboring attachment point, it computes PTK keys for the attachment points of the new neighborhood list. FIG. 4 therefore also represents the sets of PTK keys corresponding to each of the PMK keys effectively used during the example of movements.

Thus, at its first attachment to the attachment point B, the mobile terminal is assigned a key PMK₀. The preliminary authentication method enables the terminal and the attachment point C to be in possession of a key PMK_{C}, as a preliminary to the change in attachment point. Once attached to the point C and in accordance with the graph of FIG. 3, the fast authentication method achieves the creation and exchange of the keys PMK_{A}, PMK_{B}, PMK_{E} in compliance with the graph, respectively with the attachment points A, B and E. These creations and these exchanges of keys occur throughout the moving of the terminal.

Once the preliminary authentication phase has been performed, the terminal carries out an exchange of the encipherment key according to an embodiment of the invention with the target attachment point, which spares it the phase of re-authentication by a “4-way handshake”. Only the terminal and the target attachment point to which a ticket corresponds can decrypt the content of this ticket. The current attachment point is considered only as a relay. Each ticket is decryptable only by the terminal and the attachment point to which this ticket corresponds.

To ensure the pre-distribution of the keys, the fast authentication method specifies exchanges between the different entities: mobile terminal, attachment points and AAA server. We present a part of these exchanges for the example of movements chosen previously.

FIG. 5 presents the changes generated by the first attachment of the terminal 51 with the network through its association with the attachment point 52. These exchanges encompass a standard authentication 802.11i (501) with the authentication server 53 as well as the pre-distribution of the keys PMK_{C} and PTK_{C} to the neighboring attachment point 54.

A standard authentication is therefore preliminarily performed (501), leading the terminal 51, the attachment point 52 and the authentication server 53 to share the key PMK₀. The current attachment point 52 also possesses the key PMK₀. The current attachment point 52 informs (502) the authentication server 53 that the terminal 51 is accepted on the network by the current attachment point 52. The authentication server 53 will prepare a list of the neighboring attachment points for the current attachment point. In the figure, only one neighboring attachment point 54 is shown. The authentication server 53 informs (503) the attachment point 54 that a terminal 51 has been accepted on the network and asks it if it wishes to receive a key for the terminal 51. The neighboring attachment point 54 transmits (504) its acceptance to the authentication server 53 which transmits (505) the authentication key PMK_{N} to the neighboring attachment point 54.

The server 53 transmits (506) a list of neighboring attachment points to the current attachment point 52. The neighboring attachment point 52 transmits (507) a list of potential target attachment points to the terminal 51 which generates (508), for each of the potential target attachment points, an encrypted encipherment ticket. The list of the tickets is then transmitted (509) to the current attachment point 52 which in turn transmits (510) [IAPP-Cache-Notify(Ticket, Context)] the encrypted ticket to the target attachment point 54 which decrypts it and extracts its PTK from the terminal. The “Context” field may include several pieces of information such as the identifier of the mobile and optionally its field “RSN IE”, its Quality of Service profile as indicated preliminarily.

FIG. 6 provides a schematic view of the exchanges induced by a movement of the station in the network and its re-association with the attachment point C. The station gets re-authenticated with C through a “Group-Key Handshake” (without needing a “4-way Handshake” according to an embodiment of the invention) thanks to the pre-distributed keys (PMK_{C} and PTK_{C}) as described here above (FIG. 5). This re-association generates a new pre-distribution of the keys to the neighbors of C.

A standard re-association is therefore preliminarily performed (601) leading the terminal 61 and the attachment point 62 to share the key PMK_{C} and PTK_{c}. The current attachment point 62 informs (602) the authentication server 63 that the terminal 61 is accepted on the network by the current attachment point 62. The authentication server 63 will prepare a list of the neighboring attachment points for the current attachment point. The figure represents three neighboring attachment points 64. The authentication server 63 informs (603) them that a terminal 61 is accepted on the network and asks if they wish to receive a key for this terminal 61. The neighboring attachment points 64 transmit (604) their acceptance to the authentication server 63 which transmits (605) the authentication key PMKₓ to the neighboring attachment points 64.

The server 63 transmits (606) a list of neighboring attachment points to the current attachment point 62. The neighboring attachment point 62 transmits (607) a list of potential target attachment points to the terminal 61 which generates (608), for each of the potential target attachment points, an encrypted encipherment ticket. The list of the tickets is then transmitted (609) to the current attachment point 62 which in turn transmits [IAPP-Cache-Notify(Ticket, Context)] the encrypted ticket to the target attachment point 64 which decrypts it and extracts its PTK from the terminal.

### 4. Structure of a Terminal and a Mobility Controller

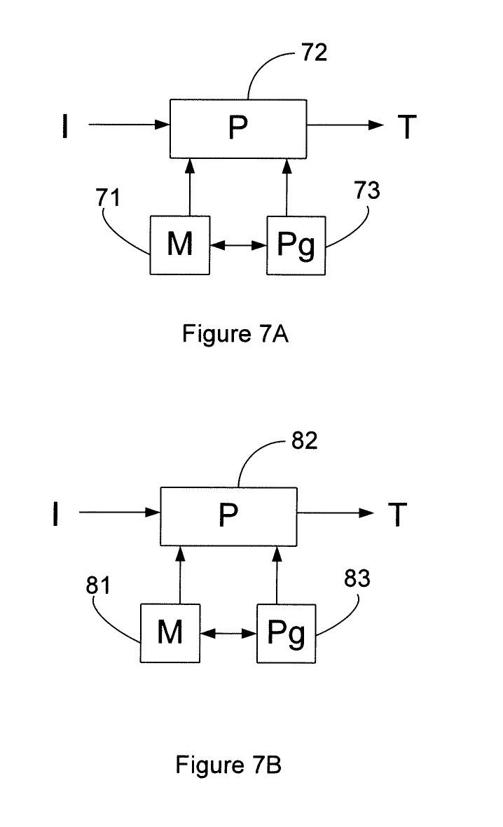

FIG. 7A presents the simplified structure of an attachment point with regard to an embodiment of the invention. This attachment point has a memory M 71, a processing unit 72 equipped for example with a microprocessor and driven by the computer program Pg 73. At initialization, the code instructions of the computer program 73 are loaded for example into a RAM and then executed by the processor of the processing unit 72. At input, the processing unit 72 receives the pieces of data 74 sent out by the different terminals (for example in the format illustrated in FIG. 3A). The microprocessor μP of the processing unit 72 decodes these pieces of data 74 according to the instructions of the program Pg 73. The processing unit 72 outputs lists of target attachment points 75 intended for the different terminals.

FIG. 7B presents the simplified structure of a terminal with regard to an embodiment of the invention. This terminal has a memory M 81, a processing unit 82 equipped for example with a microprocessor and driven by the computer program Pg 83. At initialization, the code instructions of the computer program 83 are loaded for example into a RAM and then executed by the processor of the processing unit 82. At input, the processing unit 82 receives the pieces of data 84 sent out by the current attachment point (such as the lists of target attachment points). The microprocessor μP of the processing unit 82 decodes these pieces of data 84 according to the instructions of the program Pg 83. The processing unit 82 outputs encipherment tickets 85 (for example in the form of lists) intended for the different terminals.

Although the present disclosure has been described with reference to one or more examples, workers skilled in the art will recognize that changes may be made in form and detail without departing from the scope of the disclosure and/or the appended or issued claims thereof.

1. A method of anticipated distribution of at least one encipherment key designed to secure a communication to be set up on the link layer of a cell network formed by a plurality of cells, each controlled by an attachment point, between a mobile terminal and a set of attachment points known as target attachment points, wherein the method comprises, for at least one target attachment point, the following steps:
creating an encipherment ticket containing an encipherment key, encrypted on the basis of at least one authentication key proper to this target attachment point;
receiving said encrypted encipherment key by a current attachment point to which said mobile terminal is connected;
identifying a means for decrypting said encrypted encipherment key by said at least one authentication key, making it possible to obtain said encipherment key.

2. The method of distribution according to claim 1, wherein the method furthermore comprises a step of storage, by said target attachment point, of said received encipherment ticket within a specific space, according to a predetermined preservation parameter.

3. The method of distribution according to claim 1, wherein the method comprises a preliminary step of determining said set of target attachment points by a neighborhood graph associated with said cell network.

4. The method of distribution according to claim 1, wherein said encipherment ticket is created by said terminal and said encipherment ticket furthermore comprises a first piece of information representing an identifier of said terminal.

5. The method of distribution according to claim 1, wherein said encipherment ticket is created by said target attachment point and said encipherment ticket furthermore comprises a first piece of information representing an identifier of said terminal.

6. The method of distribution according to claim 1, wherein the method furthermore comprises a preliminary step of transmission, for each target attachment point, of a second piece of information representing a possible implementation of a handover procedure from said mobile terminal.

7. The method of distribution according to claim 6, wherein said second piece of information furthermore comprises a piece of data belonging to the group comprising:
an identity of said terminal;
a piece of information representing a piece of authentication material proper to said terminal.

8. The method of distribution according to claim 6, wherein the method comprises a step of temporarily saving said second piece of information up to the implementation of said handover procedure.

9. The method of distribution according to claim 8, wherein the method comprises a step of eliminating said second piece of information when a time limit for saving said second information is reached.

10. A system of anticipated distribution of at least one encipherment key designed to secure a communication to be set up on the link layer of a cell network formed by a plurality of cells, each controlled by an attachment point, between a mobile terminal and a set of attachment points known as target attachment points, wherein the system comprises, for at least one target attachment point:
means for creating an encipherment ticket containing an encipherment key, encrypted on the basis of at least one authentication key proper to this target attachment point;
means for receiving said encrypted encipherment key by a current attachment point to which said mobile terminal is connected;
means for identifying a means for decrypting said encrypted encipherment key by said at least one authentication key, making it possible to obtain said encipherment key.

11. A device capable of acting in a system of anticipated distribution of at least one encipherment key designed to secure a communication to be set up on the link layer of a cell network formed by a plurality of cells, each controlled by an attachment point, between a mobile terminal and a set of attachment points known as target attachment points, wherein the device comprises:
means for creating an encipherment ticket containing an encipherment key, encrypted on the basis of at least one authentication key proper to this target attachment point.

12. An attachment point capable of acting within a system of anticipated distribution of at least one encipherment key designed to secure a communication to be set up on the link layer of a cell network formed by a plurality of cells, each controlled by an attachment point, between a mobile terminal and a set of attachment points known as target attachment points, wherein the attachment point comprises:
means for receiving an encipherment ticket containing an encipherment key, encrypted on the basis of at least one authentication key proper to said target attachment point, by a current attachment point to which said mobile terminal is connected.

13. The attachment point according to claim 12, wherein the attachment point comprises means for identifying a means for decrypting said encrypted encipherment key received, by said at least one authentication key, making it possible to obtain said encipherment key.

14. A computer program product recorded on a computer-readable carrier and executable by a micoprocessor and comprising program code instructions for implementing a method of anticipated distribution of at least one encipherment key designed to secure a communication to be set up on the link layer of a cell network formed by a plurality of cells, each controlled by an attachment point, between a mobile terminal and a set of attachment points known as target attachment points, wherein the method comprises, for at least one target attachment point, the following steps:
creating an encipherment ticket containing an encipherment key, encrypted on the basis of at least one authentication key proper to this target attachment point;
receiving said encrypted encipherment key by a current attachment point to which said mobile terminal is connected;
identifying a means for decrypting said encrypted encipherment key by said at least one authentication key, making it possible to obtain said encipherment key.
